(19) United States
(12) Patent Application Publication
(10) Pub. No.: US 2007/0246324 A1
(43) Pub. Date: Oct. 25, 2007

(54) Driving Device For Passage Gates Or Thorougfare Gates And Door Or Gate Drives

(75) Inventor: Lothar Lais, Schopfheim (DE)

Correspondence Address: Horst M. Kasper, 13 Forest Drive, Warren, NJ, 07059, US

(73) Assignee: MAGNETIC AUTOCONTROL GMBH, Schopfheim (DE)

(21) Appl. No.: 10/579,518

(22) PCT Filed: Nov. 12, 2004
(86) PCT No.: PCT/DE04/02499

§ 371 Date: Apr. 6, 2007

(30) Foreign Application Priority Data
Nov. 14, 2003 (DE) 103 53 366.4

(51) Int. Cl. E05F 15/12

(52) U.S. Cl. 193/31 A

(57) ABSTRACT

Disclosed is a driving device for passage gates or thoroughfare gates and door or gate drives. Said driving device comprises a brushless DC servo motor to which a servo regulator is assigned. The output shaft of said DC servo motor is directly connected to the drive shaft of the locking element. The DC servo motor can be accurately regulated to a great extent regarding rotational speed, torque, etc. and can be adapted to different requirements via the servo regulator such that the same motor can be used for many different applications along with said servo regulator, i.e. a continuous drive system is created. Coupling gears and reduction gears, i.e. parts that are prone to malfunction and wear, can be dispensed with due to the fact that the locking element is directly driven, thus requiring less maintenance work at greater intervals.

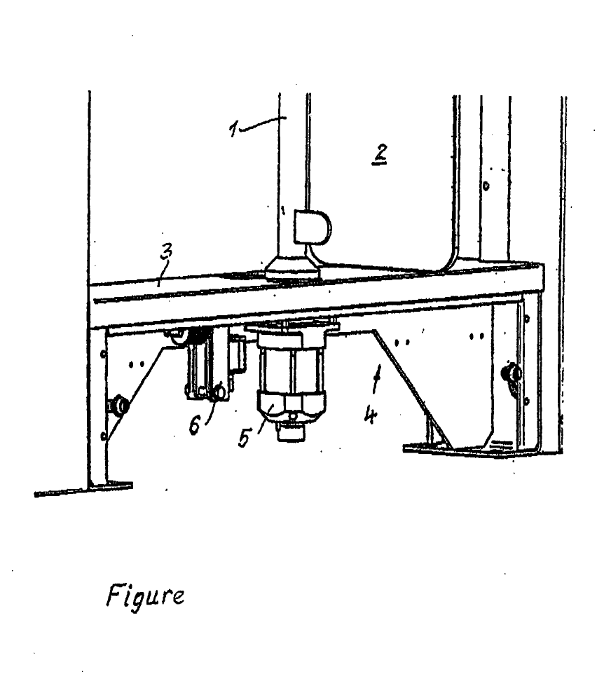

The invention relates to a drive device for passage barriers or thoroughfare barriers and door or gate drives, having a brushless DC servo motor.

There are drive devices for thoroughfare barriers, such as barrier arms and other heavy barrier elements, having a brushless DC motor or servo motor, in which drive devices the motor drives the barrier element in question by a step-down gear mechanism and an additional linkage.

One of the advantages of using brushless DC servo motors in such drives is that they can be controlled easily compared to AC motors. They are also considerably more efficient and more dynamic. The drive devices can be used in a very wide variety of geographical regions, in which the power supply is provided at different voltage levels and different frequencies.

A drive device of this type is described in the published US patent application US 2003/0029089 A1. The purpose of the step-down gear mechanism is to reduce the high rotational speed of the motor and to multiply the low drive torque of the drive motor. A control loop controls the power output by the DC motor in accordance with the power which is required to move a barrier element and may possibly change during the movement sequence. The linkage is used to transmit the movement of the drive motor to the barrier element. The special mechanics of said linkage also produce a sinusoidal movement profile of the barrier element, so that the end positions of the barrier element are approached smoothly. However, the controller for a DC motor is very expensive. In addition, known DC motors are likewise very complicated and costly to produce. The carbon brushes of simple DC motors, which brushes are used for commutation, usually wear out very quickly and therefore limit the service life of these DC motors. The mechanics of the linkage are susceptible to faults and wear.

In the case of barriers with a turnstile or the like as the barrier element, it is known to connect this barrier element downstream of the step-down gear mechanism. In the case of swing barriers or barrier arms and the like, complicated mechanics, usually in the form of the linkage, are connected downstream of the step-down gear mechanism in order to convert the rotary movement of the gear mechanism motor into a pivoting movement of the barrier member. EP 0290 957 B1 describes a drive device with a drive motor and a linkage which is connected downstream.

Pedestrian barriers have to meet high requirements in terms of safety and protecting people; people must never be put at any risk but on the other hand said pedestrian barriers have to be very quick to react. It has to be possible to initiate the closing movement, for example in order to deny access or passage to an unauthorized person, very quickly and then also proceed quickly, without putting the person in question at any risk. In this case, gear mechanisms and complicated mechanics are obstructive and impose limits.

The known drive devices have a large number of mechanical parts which are very susceptible to wear and as a result may require expensive maintenance work or repairs, and this is particularly disadvantageous especially for passage barriers or thoroughfare barriers which are used frequently. Barriers such as this should operate for years without problems as far as possible and have to complete an extremely high number of movements during this time. Depending on the type of barrier, different but consistently high safety requirements, specifically for protecting people, have to be observed in this case too. In order, for example, to prevent unauthorized access at pedestrian barriers by a person immediately following an authorized person, so-called tailgating, barriers which react and close quickly are required in addition to the corresponding sensor system. However, barriers which close quickly run the risk of injuring the people passing through. It is therefore absolutely necessary for it to be possible to immediately stop and/or reverse the drive for the barrier element when a person is detected in the barrier region, and this likewise leads to a high load in the mechanics. The noise which is produced by the moving parts of the mechanics is also found to be disruptive. The gear mechanism is also obstructive if the barrier is to be automatically opened in the event of a power cut.

An extremely wide variety of barriers are used, depending on safety requirements and frequency of use. The various designs also call for motors and gear mechanisms of a very wide variety of shapes and sizes. This variety of drives and components causes logistics problems for the manufacturer, leads to only small numbers being produced and therefore to high costs and prices.

The object of the invention is to provide a drive device which manages with as few components which are subject to wear as possible and allows smooth acceleration and braking of the moving bodies and permits the barrier to run as quietly as possible. The aim is for the novel drive device to be suitable for as many types of passage barrier and thoroughfare barrier as possible, but in particular for a very wide variety of pedestrian barriers, and therefore to drastically reduce the variety of different drives which have been required to date. It should ideally be possible to operate all previously known types of passage barrier and thoroughfare barrier with one and the same type of motor throughout the world. In order to protect people, it must be possible to control the servo motor which is used.

According to the invention, this is achieved in that the DC servo motor has an associated servo controller and the output shaft of the DC servo motor is directly connected to the drive shaft of the barrier element.

Since the same motor having a servo controller can be used for all types of passage barrier, both the motor and the servo controller can be produced significantly more cost-effectively and at reasonable prices.

The rotational speed of the motor can be controlled exactly by the servo controller. The torque and therefore the force which is applied to the element which is to be moved can be adapted and/or limited at the servo controller by software, in accordance with the respective requirements. Movement profiles, such as smooth acceleration and braking, can be prespecified. The direct drive means that the step-down gear mechanism and linkage can be dispensed with, as a result of which manufacturing costs are reduced further. The parts which are subject to wear are reduced to an absolute minimum, so that the drive device runs almost silently. Said drive device can be used universally and adapted to a very wide variety of requirements throughout the world. Less maintenance work is required at longer intervals with a longer operating time. The drive system which can be used for a very wide variety of areas of application also simplifies logistics.

The motor is preferably controlled as a function of signals by a compact complete control device which comprises the servo controller and a logic section.

The logic section may advantageously be designed as a pluggable logic circuit board. Since different logic circuit boards can be plug-connected, different movement profiles which are directed at various applications are prespecified on said logic circuit boards, and said logic circuit boards have different numbers of inputs and outputs and different operator control and display elements etc., depending on requirements, it is possible, starting from a basic design, to also adapt the drive device directly on-site to a very wide variety of requirements and prespecifications in an optimum manner.

A transmitter system which supplies the required control signals can preferably be integrated in the motor. In this case, it is advantageous when the motor mount is formed as a fixed mount on the side of the transmitter system, in order to minimize or totally eliminate axial deviations. The transmitter may be connected, for example, to the motor plate by means of plug connection or clamping, with the plug used preferably being designed to be secure against polarity reversal and preferably being provided with a locking means for safe operation.

The invention is explained below by way of example with reference to the attached drawing.

The figure shows the lower part of a pedestrian barrier with a flap 2 which can be pivoted about a post 1 as the barrier element. A shaft (not visible in the drawing) which executes the pivoting movement runs in the post id; it penetrates the plate 3 of a table-like base 4 and beneath the plate 3 is connected directly, that is to say without the interconnection of a gear mechanism, to a brushless DC servo motor 5. In addition to the motor 5, a locking unit 6 is provided for safe operation, said locking unit holding the barrier element securely in its closed position and its open position and allowing the motor 5 and, respectively, the barrier element 2 to stop in any position.

For all types of barrier, in particular pedestrian barriers, in which the barrier element has to execute a pure rotary or pivoting movement, provision is therefore made to use a brushless DC servo motor 5 with a servo controller as the direct drive, that is to say without the interconnection of a gear mechanism, in other words to connect the output shaft of the DC servo motor 5 directly to the barrier element 2. The rotational speed and torque of the motor 5 can be controlled independently of the direction of rotation and over the entire range of motion as desired. It is possible to preset acceleration profiles with acceleration and braking ramps at the beginning and end of a movement in order to create smooth running behavior without overshooting and without sudden loads in the end positions, it also being possible to position said barrier very accurately. Commutation and position control in the motor can be performed by means of a magnetoresistive sensor in conjunction with a magnet wheel or a polarized magnetic ring. All other systems, such as resolvers, encoders and Hall sensors are possible, depending on the positioning accuracy required. Additional sensors or limit switches are not required for positioning purposes.

The motor is controlled by means of a compact complete control device which comprises the actual servo controller circuit board, an electronic circuit board which contains the logic section, and a control housing. The control housing is preferably composed of an aluminum extruded profile with retaining devices (rails) integrated in the profile cross section for inserting the circuit board and screw channels for fixing the lateral and the upper cover plate. One of the lateral cover plates is ideally firmly connected to the output stage modules of the servo controller and as a result serves simultaneously as a heat sink and to fix the servo controller circuit board in the control housing. The servo controller and the logic section communicate via a bus and therefore require only one connection. Corresponding apertures are provided in the lateral and in the upper cover plate for the input and output terminals or plugs.

Since a very wide variety of programmable logic circuit boards which are designed for various application options and extension levels and are accordingly adapted are provided, the same drive device can immediately be made ready for use for the respective application by extremely simple measures, namely by installing the corresponding logic circuit board or by replacing it or by changing the program, and can also subsequently be matched to the respective requirements or customer wishes on-site without problems. An integrated voltage controller means one and the same drive device can be used for all mains voltages between 100 volts and 265 volts and 50 Hz and 60 Hz. A large power range can be covered by one control means.

Another embodiment provides a connection voltage of 48 volts DC. In this case, a corresponding transformer or mains component is connected upstream of the complete control device; the control device itself is of identical design for all supply voltages throughout the world.

One further refinement of the invention provides for the inputs and outputs to be separate from the actual motor control system and designed as an independent module. In this case, the connection to the motor control system/logic circuit board is made via a pluggable bus connection or a pluggable multicore cable, for example a flat cable. In this refinement, the sensitive multilayer motor control circuit board and, respectively, the logic circuit board remain protected when mechanical loads are connected; these loads are then absorbed by the insensitive connection circuit board of the connection module and possible damage as a result of improper handling does not lead to the expensive motor/logic circuit board being damaged.

If required, the barrier element can be locked in the end positions by means of a separate locking unit which is fitted on the motor or else is independent of the motor. In the event of a power cut, the barrier element is automatically moved to its open position, preferably by energy storage means in the intermediate circuit of the servo controller, so that unobstructed passage is possible in spite of the fault. In this case, the embodiment of the drive device as a direct drive has the advantage that blocking does not occur on account of the efficiency of the gear mechanism (for example in the case of worm gear mechanisms) in the event of a power cut. As an alternative, the system can also be changed over to battery operation in the event of a power cut, for which reason the motor then has to be designed for a safety extra-low voltage.

On the other hand, in the case of elements which are to be moved and execute a combined movement, such as barrier arms or leaf and sliding elements, or relatively large pedestrian barriers, such as large or heavy revolving rotary doors, it is still advantageously possible to connect a step-down gear mechanism and/or, if required, additionally also a linkage between the servo motor and the element which is to be moved.

### LIST OF REFERENCE SYMBOLS

l Post
2 Flap, barrier element
3 Plate
4 Base
5 DC servo motor
6 Locking unit

1. A drive device for passage barriers or thoroughfare barriers and door or gate drives, having a brushless DC servo motor, characterized in that the DC servo motor (5) has an associated servo controller and the output shaft of the DC servo motor (5) is connected directly to the drive shaft of the barrier element (2 ).

2. The drive device as claimed in claim 1, characterized by a compact complete control device which comprises the servo controller and a logic section and a housing, and which serves to control the motor (5) as a function of signals.

3. The drive device as claimed in claim 2, characterized in that the logic section is designed as a pluggable logic circuit board.

4. The drive device as claimed in claim 3, characterized in that different logic circuit boards can be plug-connected, different movement profiles and programs which are directed at various applications are prespecified on said logic circuit boards, and said logic circuit boards have different numbers of inputs and outputs and different operator control and display elements, depending on requirements.

5. The drive device as claimed in claim 1, characterized by a transmitter system which is integrated in the motor and supplies the required control signals.

6. The drive device as claimed in claim 6, characterized in that the motor mount is formed as a fixed mount on the side of the transmitter system.

7. The drive device as claimed in claim 6, characterized in that the transmitter system is connected to the motor plate by means of plug connection or clamping.

8. The drive device as claimed in claim 8, characterized in that the plug connection is designed to be secure against polarity reversal and is provided with a locking means.

9. The drive device as claimed in claim 1, characterized in that commutation and position control in the motor are performed by means of a magnetoresistive sensor.

10. The drive device as claimed in claim 1, characterized in that commutation and position control in the motor are performed by means of resolvers or encoders or Hall sensors.

11. The drive device as claimed in claim 1, characterized in that a linkage can be interconnected between the servo motor and the barrier element which is to be moved.

12. The drive device as claimed in claim 1, characterized in that a step-down gear mechanism and a linkage can be interconnected between the servo motor and the element which is to be moved.

13. The drive device as claimed in claim 2, characterized in that the inputs and outputs are separate from the actual motor control system/logic circuit board and designed as an independent module.

14. The drive device as claimed in claim 13, characterized in that the inputs and outputs can be connected by a pluggable bus connection or a pluggable, multicore cable.
